(19) United States
(12) Patent Application Publication
(10) Pub. No.: US 2016/0068039 A1
(43) Pub. Date: Mar. 10, 2016

(54) VEHICLE AIR-CONDITIONING DEVICE

(71) Applicant: DENSO CORPORATION, Aichi (JP)

(72) Inventor: Kouji YAMADA, Kariya-city (JP)

(21) Appl. No.: 14/787,487

(22) PCT Filed: May 7, 2014
(86) PCT No.: PCT/JP2014/002418

§ 371 Date: Oct. 28, 2015

(30) Foreign Application Priority Data
May 8, 2013 (JP) 2013-098726

(51) Int. Cl. B60H 1/00

(52) U.S. Cl. CPC B60H 1/00564

(57) ABSTRACT

A vehicle air-conditioning device includes an inside/outside air case that selectively sends outside air, which is air outside of a vehicle, and inside air, which is air that circulates inside the vehicle, into a blower casing. An opening end surface of the inside/outside air case that is connected to an additional duct includes a sealing surface. The sealing surface includes a recessed portion, into which a protruding portion is fitted, formed in an end portion of the additional duct. Accordingly, it is possible to directly connect the inside/outside air case to the vehicle outside-air inlet without using the additional duct. Conversely, the vehicle outside-air inlet and the inside/outside air case can be connected to each other via the additional duct when the additional duct is used.

### CROSS-REFERENCE TO RELATED APPLICATION

The present application is based on Japanese Patent Application No. 2013-98726 filed on May 8, 2013, the content of which is incorporated herein by reference.

### TECHNICAL FIELD

The present disclosure relates to a vehicle air-conditioning device which performs air conditioning inside a vehicle. Specifically, this disclosure relates to an inside/outside air switching unit in a vehicle air-conditioning device which selectively takes in air among inside air and outside air, and sends the air to an air conditioning duct.

### BACKGROUND ART

In the related art, a vehicular inside/outside air switching unit described in Patent Literature 1 is known. A vehicle air-conditioning device is provided with an air conditioning duct having a heat exchanger which is called an evaporator or a condenser therein. An inside and outside air switching unit is provided on an upstream side of the air conditioning duct.

In the inside/outside air switching unit, a blower which sends conditioning air into the air conditioning duct of the vehicle air-conditioning device is accommodated in a blower casing. An inside/outside air case which accommodates a damper is provided at an upper end of the blower casing. An inside air inlet port which introduces inside air is provided on one side of the inside/outside air case, and an outside air inlet port which introduces outside air is provided on the other side.

### PRIOR ART LITERATURE

### Patent Literature

Patent Literature 1: JP H04-328016 A

### SUMMARY OF THE INVENTION

The outside air inlet port is provided on a vehicle side, and is connected to a vehicle outside-air inlet which sucks in the outside air. Sealing packing is pinched and the sealing of a connection portion is formed on a connection surface between the outside air inlet port and the vehicle outside-air inlet. When one inside/outside air case is commonly used in different vehicles, it is necessary to connect the outside air inlet port of the inside/outside air case and the vehicle outside-air inlet. However, when the size of the inside/outside air case is set to match one type of the vehicle, there is a concern that the inside/outside air case is not appropriate for other types of vehicles.

Here, it can be considered that an additional duct is provided, the additional duct which has a different length for each vehicle is set, and the inside/outside air case and the vehicle outside-air inlet are connected to each other by the additional duct. However, the additional duct needs to have an airtight structure and a waterproof structure by providing sealing packing between the additional duct and the vehicle outside-air inlet. However, it is also necessary to provide the sealing packing between the additional duct and the inside/outside air case, and to establish the airtight and waterproof structures. In addition, it is necessary to provide a structure in which the inside/outside air case and the additional duct can be combined with each other, and thus, an extremely complicated structure is required.

An object of the present disclosure is to provide a vehicle air-conditioning device which can connect an inside/outside air case to a vehicle outside-air inlet without providing an additional duct, or which can connect the vehicle outside-air inlet and the inside/outside air case to each other via the additional duct.

The description in the Patent Literature listed as the related art can be introduced or employed as a reference for describing technical elements described in the specification.

To attain the above object, the present disclosure adopts technical means as below. In a first disclosure, an air conditioning duct having a heat exchanger that adjusts a temperature of conditioning air, a blower casing disposed upstream of the air conditioning duct, the blower casing housing therein a blower that blows the conditioning air into the air conditioning duct, an inside/outside air case having a damper that selectively sends outside air, which is air outside of a vehicle, and inside air, which circulates inside the vehicle, into the blower casing, a vehicle outside-air inlet taking in the outside air, and an additional duct disposed between the vehicle outside-air inlet and the inside/outside air case, the additional duct sending the outside air into the inside/outside air case, are provided. Further, a sealing surface formed on an opening end surface of the inside/outside air case that is connected to the additional duct, the sealing surface being configured to be connectable to the vehicle outside-air inlet, and a protruding portion formed on an end portion of the additional duct, and a recessed portion formed in the sealing surface, the recessed portion connecting the inside/outside air case to the additional duct when the protruding portion is fitted into the recessed portion, are provided.

According to the first disclosure, the additional duct is provided between the vehicle outside-air inlet, which is provided on the vehicle side to send the outside air into the inside/outside air case and takes in the outside air, and the inside/outside air case. In addition, a sealing surface which can be connected to the vehicle outside-air inlet is provided at a part of the inside/outside air case which is connected to the additional duct. Therefore, when the additional duct is not provided between the vehicle outside-air inlet and the inside/outside air case, it is possible to directly connect the vehicle outside-air inlet to the inside/outside air case at the sealing surface. In addition, when the additional duct is provided between the vehicle outside-air inlet and the inside/outside air case, the protruding portion provided in the end portion of the additional duct is fitted into the recessed portion of the sealing surface. It is possible to easily connect the inside/outside air case to the additional duct as the protruding portion is fitted into the recessed portion. In other words, when the vehicle outside-air inlet and the inside/outside air case are connected to each other, the additional duct may be selectively used or not used. For this reason, among vehicles having different dimensions, it is possible to use an inside/outside air case that is standardized to have the same dimensions (specification).

In a second disclosure, the end portion of the additional duct includes an annular wall portion that inserts more further inside the inside/outside air case than the sealing surface when the additional duct and the inside/outside air case are connected to each other.

According to the second disclosure, even when water infiltrates together with the outside air from the vehicle outside-air inlet, the water is guided into the inside/outside air case along the annular wall portion which inserts more further inside the inside/outside air case than the sealing surface. Accordingly, there is no case where the water is guided to an outside of the inside/outside air case through a space between the additional duct and the inside/outside air case. Therefore, it is possible to suppress the water to infiltrate into an unpredicted part of the vehicle.

In a third disclosure, the sealing surface includes an annular flat portion on which a sealing packing is disposed, the opening end surface includes an outside air inlet port through which the outside air is introduced to an inner circumferential side of the flat portion, and the recessed portion is formed in the flat portion.

According to the third disclosure, the sealing surface has an annular flat portion on which the sealing packing is disposed. Therefore, it is possible to dispose the annular sealing packing on the flat portion, and to directly combine the vehicle outside-air inlet to the inside/outside air case by reliable sealing. In addition, since the outside air is introduced to the inner circumferential side of the flat portion, and the recessed portion is provided in the flat portion, it is possible to dispose the sealing packing in the flat portion.

In a fourth disclosure, the protruding portion is an annular protruding portion that annually surrounds a periphery of the outside air inlet port of the inside/outside air case, and the annular wall portion is disposed at an inner circumferential side of the annular protruding portion.

According to the fourth disclosure, even when the water infiltrates into the additional duct together with the outside air, since the water is surrounded by both the annular wall portion on the inner circumferential side and the annular protruding portion on the outer circumferential side, it is possible to more reliably prevent the water from leaking to an outside of the additional duct or the inside/outside air case. Therefore, it is possible to suppress the water to infiltrate to an unpredicted part of the vehicle.

### BRIEF DESCRIPTION OF THE DRAWINGS

FIG. 1 is a schematic view illustrating a relationship between an inside/outside air case, an additional duct, and a vehicle outside-air inlet in a first embodiment.

FIG. 2 is a schematic view illustrating a state where the additional duct and the inside/outside air case are combined with each other in the first embodiment.

FIG. 3 is a partially enlarged cross-sectional view of a part illustrated with Y3 of FIG. 2.

FIG. 4 is a partially enlarged cross-sectional view of a part illustrated with Y4 of FIG. 2.

FIG. 5 is a partially enlarged cross-sectional view of a part along line of arrow Y5-Y5 of FIG. 2.

FIG. 6 is a schematic view illustrating a state where the inside/outside air case and the vehicle outside-air inlet are directly connected to each other without providing the additional duct in the first embodiment.

FIG. 7 is a schematic view illustrating a shape of an end surface of an opening portion of an outside air inlet port of the inside/outside air case when viewed from a direction illustrated with an arrow Y7 of FIG. 6.

### EMBODIMENTS FOR CARRYING OUT INVENTION

Hereinafter, plural embodiments for carrying out the present disclosure will be described with reference to the drawings. In each embodiment, there is a case where the parts which correspond to the contents described in previous embodiments are given the same reference numerals, and overlapping description thereof is omitted. When a part of the configuration is described in each embodiment, other parts of the configuration can employ other embodiments which are previously described.

In each embodiment, it is possible not only to combine the parts of which the possibility of combination is clearly and specifically described with each other, but also to partially combine the embodiments even without clear description of the possibility of combination, as long as the combination does not cause any particular failure.

### First Embodiment

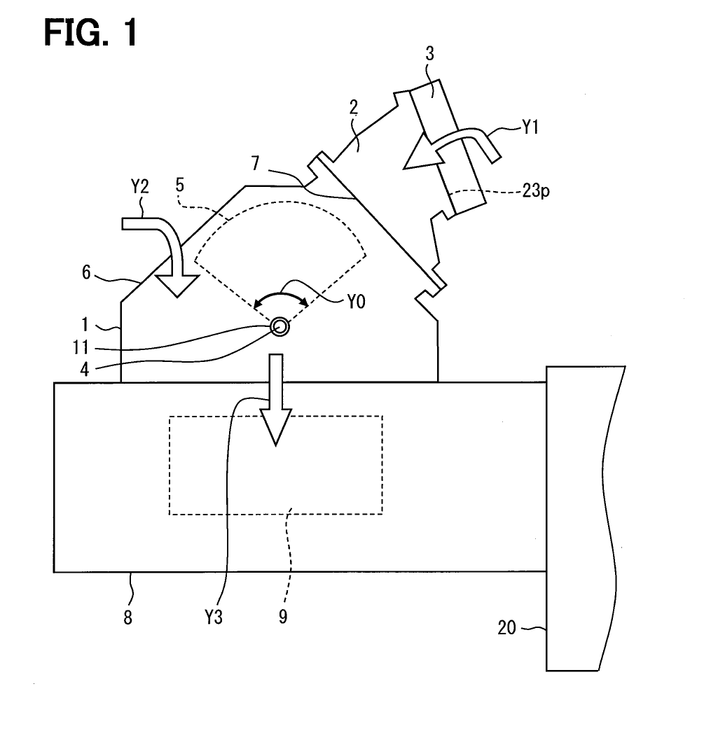

Hereinafter, a first embodiment will be described in detail with reference to FIGS. 1 to 7. FIG. 1 illustrates a relationship of an inside/outside air case 1, an additional duct 2, and a vehicle outside-air inlet 3 in the first embodiment. A damper 5 which laterally rotates around a shaft member 4 is provided in the inside/outside air case 1. In reality, the vehicle outside-air inlet 3 is an opening portion which is provided in a partition wall that partitions an engine room and the vehicle interior, and takes in outside air, but is schematically illustrated in FIG. 1.

A case where the inside/outside air case 1 introduces air from the vehicle interior through an inside air inlet port 6 by the rotation along an arrow Y0 direction of the damper 5, and a case where the air of the outside of the vehicle is introduced from an outside air inlet port 7, are switched. In addition, inside air or outside air introduced into the inside/outside air case 1 is guided to a blower casing 8 which is connected to the inside/outside air case 1. A blower 9 which is configured of a centrifugal fan is provided in the blower casing 8. In addition, conditioning air is supplied to an air conditioning duct 20 by the blower 9.

A heat exchanger, which is not illustrated and cools or heats the conditioning air, or an air mix damper, which adjusts a level of cooling or heating, is provided in the air conditioning duct 20. The conditioning air which passed through the air conditioning duct 20 is guided into the vehicle interior from an outlet which is not illustrated.

It is necessary that the outside air inlet port 7 of the inside/outside air case 1, which is a boundary portion between the inside/outside air case 1 and the additional duct 2, is sealed so that the water which infiltrates together with the outside air does not leak to the outside from the connection portion between the additional duct 2 and the inside/outside air case 1. In other words, it is necessary to combine the additional duct 2 and the inside/outside air case 1 to be in a sealed state. A sealing packing 23P is provided between the vehicle outside-air inlet 3 and the additional duct 2. An arrow Y1 illustrates a flow of the outside air which is guided into the additional duct 2 via the vehicle outside-air inlet 3. An arrow Y2 illustrates a flow of the inside air, in which the inside air which is air that circulates in the vehicle interior is introduced into the inside/outside air case 1.

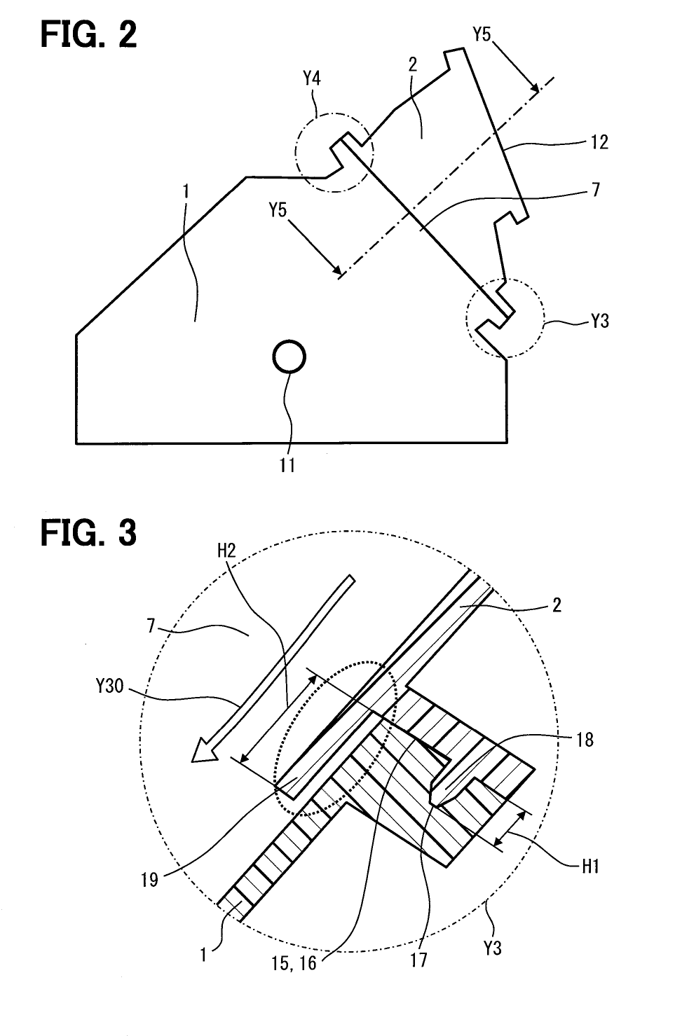

FIG. 2 illustrates a state where the additional duct 2 and the inside/outside air case 1 are combined with each other. A shaft hole 11 into which a shaft of the damper 5 is inserted is provided in the inside/outside air case 1. The boundary portion between the inside/outside air case 1 and the additional duct 2 becomes the outside air inlet port 7 of the inside/outside air case 1. An outside air inlet port 12 of the additional duct 2 is provided at a tip end of the additional duct 2. The inside/outside air case 1 and the additional duct 2 are molded by using the same synthesized resin, for example, polypropylene.

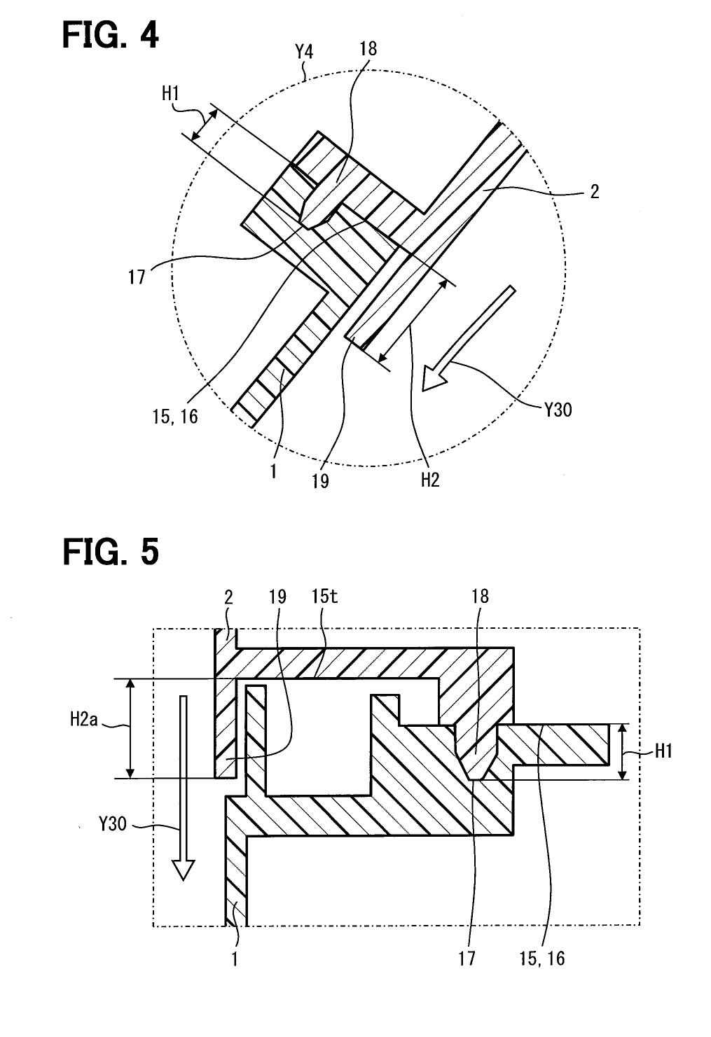

FIG. 3 enlarges and illustrates a part illustrated with Y3 of FIG. 2. In FIG. 3, the additional duct 2 and the inside/outside air case 1 are combined with each other by being fitted to each other. Next, FIG. 4 partially enlarges and illustrates a part illustrated with Y4 of FIG. 2, and illustrates a fitting portion between the inside/outside air case 1 and the additional duct 2. Furthermore, FIG. 5 partially enlarges and illustrates a part along a line of arrows Y5-Y5 of FIG. 2.

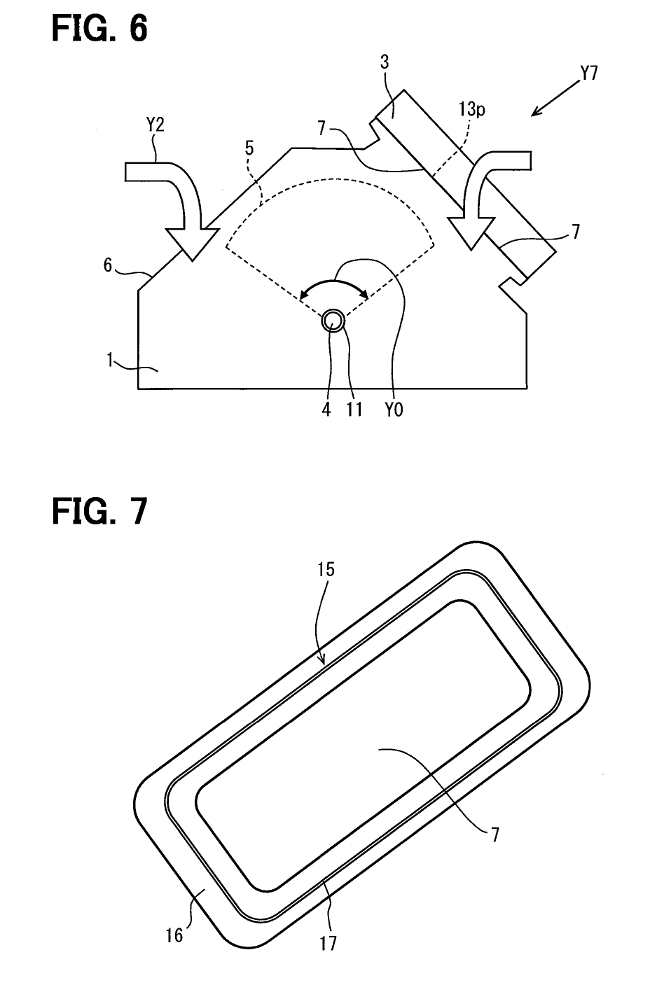

FIG. 6 illustrates a state where the inside/outside air case 1 and the vehicle outside-air inlet 3 of FIG. 1 are directly connected to each other without the additional duct 2. A rubber-made sealing packing 13p is provided in a connection portion between the outside air inlet port 7 in the inside/outside air case 1 and the vehicle outside-air inlet 3. A sealing surface 16 which will be described later is provided at a part where the inside/outside air case 1 and the additional duct 2 are connected to each other.

FIG. 7 schematically illustrates a shape of an opening end surface 15 of the outside air inlet port 7 of the inside/outside air case 1 when viewed from a direction illustrated with an arrow Y7 of FIG. 6. The inside/outside air case 1 and the additional duct 2 are connected to each other by the opening end surface 15 as illustrated in FIG. 2, and in another case, the vehicle outside-air inlet 3 is directly attached to the inside/outside air case 1 as illustrated in FIG. 6. A part of the opening end surface 15 is provided with the sealing surface 16 to which the sealing packing 13p is closely connected.

A case where the opening end surface 15 in FIG. 7 and the vehicle outside-air inlet 3 are directly connected to each other without using the additional duct 2 will be described. The air which comes out from the blower casing 8 in FIG. 1 flows into the air conditioning duct 20 which is provided with the heat exchanger, which is not illustrated, and adjusts the temperature of the conditioning air. The blower 9 which sends the conditioning air into the air conditioning duct 20 is provided on an upstream side of the air conditioning duct 20. The blower 9 is provided in the spiral type blower casing 8.

The blower 9 includes the centrifugal fan which rotates by a blower motor, which is not illustrated, and sucks the wind in the inside/outside air case 1 from the center of the centrifugal fan as illustrated with the arrow Y3. The damper 5 which selects and sends the outside air on the outside of the vehicle and the inside air on the inside of the vehicle into the blower casing 8 is provided in the inside/outside air case 1. The flow of the air, from the inside air inlet port 6 illustrated with the arrow Y2, or the flow of the air of the outside air illustrated with the arrow Y1, which is selected by the damper 5, is generated by the rotation of the blower 9.

In order to take the outside air into the inside/outside air case 1, without the additional duct 2 between the vehicle outside-air inlet 3 provided on the vehicle side and the inside/outside air case 1, it is possible to directly connect the inside/outside air case 1 to the vehicle outside-air inlet 3 as illustrated in FIG. 6.

The configuration illustrated in FIG. 1 or the configuration illustrated in FIG. 6 may be used according to the type of the vehicle provided with the inside/outside air case 1. In other words, by matching the attachment dimension of the vehicle, the additional duct 2 may be used as illustrated in FIG. 1 or may be not used.

In addition, if plural dimensions of the additional duct 2 which are different from each other are prepared, the inside/outside air case 1 having a standard (specification) common to multiple vehicles can be used. As illustrated in FIGS. 3 and 7, the sealing surface 16 is provided at a part which connects the inside/outside air case 1 to the additional duct 2, and connects the inside/outside air case 1 and the additional duct 2 to each other. In addition, the sealing surface 16 is configured to be capable of being connected to the vehicle outside-air inlet 3. The sealing surface 16 includes a flat portion on which the sealing packing (13p of FIG. 6) can be disposed.

In other words, when the additional duct 2 is used, the sealing surface 16 is connected to an end portion of the additional duct 2 as illustrated in FIGS. 1 and 2. Meanwhile, when the additional duct 2 is not used, the sealing surface 16 is connected to the vehicle outside-air inlet 3 as illustrated in FIG. 6 via the sealing packing 13p.

As illustrated in FIG. 7, a recessed portion 17 is formed in an annular shape in the sealing surface 16. As illustrated in FIGS. 3 to 5, the recessed portion 17 is fitted to a protruding portion 18 provided in the end portion of the additional duct 2. The protruding portion 18 is formed in an annular shape in the end portion of the additional duct 2, and as illustrated in FIGS. 3 to 5, a fitting portion 17, 18 is formed as the protruding portion 18 and the recessed portion 17 are fitted to each other.

As illustrated in FIGS. 3 to 5, an annular wall portion 19 is provided in the end portion of the additional duct 2. When the additional duct 2 and the inside/outside air case 1 are connected to each other, the wall portion 19 enters deeply into the inside/outside air case 1 on an inner circumferential side of the opening end surface 15.

The flat portion (hereinafter, the flat portion will use the same reference numeral 16 as that of the seal surface portion) provided in the sealing surface 16 is formed in an annular shape. When the inside/outside air case 1 and the vehicle outside-air inlet 3 are directly connected to each other, the sealing packing 13p is provided in the flat portion 16. The annular recessed portion 17 is provided making a circle in the sealing surface 16. The outside air inlet port 7 into which the outside air is introduced is provided more on the inner circumferential side than the sealing surface 16, on the opening end surface 15. In other words, the recessed portion 17 is provided to surround the periphery of the outside air inlet port 7.

As illustrated in FIGS. 3 to 5, the protruding portion 18 provided in the additional duct 2 surrounds the periphery of the outside air inlet port 7 of the inside/outside air case 1 in an annular shape. Hereinafter, the protruding portion 18 is called an annular protruding portion 18. In addition, the annular wall portion 19 provided in the end portion of the additional duct 2 is provided on the inner circumferential side of the annular protruding portion 18. In addition, when the inside/outside air case 1 and the additional duct 2 are combined with each other, the protruding portion 18 and the annular wall portion 19 are substantially parallel to each other (refer to FIGS. 3 to 5).

As illustrated in FIG. 3, a height H2 from the opening end surface 15 to a tip end of the annular wall portion 19 is set to be higher than a height H1 from the opening end surface 15 to a tip end of the protruding portion 18. Even in FIG. 4, the height H2 from the opening end surface 15 to the tip end of the annular wall portion 19 is set to be higher than the height H1 from the opening end surface 15 to the tip end of the protruding portion 18. In FIG. 5, a height H2a from an opening end surface 15t on the additional duct 2 side to the tip end of the annular wall portion 19 is set to be higher than the height H1 from the opening end surface 15 to the tip end of the protruding portion 18.

As illustrated in FIG. 5, the height H1 of the protruding portion 18 is a length from the opening end surface 15 on the inside/outside air case 1 side having the sealing surface 16 at which the additional duct 2 and the inside/outside air case 1 are close to each other, to the tip end of the protruding portion 18. In addition, the height H2a of the annular wall portion 19 is a height from the opening end surface 15t on the inside/outside air case 1 side of the additional duct 2 at which the additional duct 2 and the inside/outside air case 1 are close to, to the tip end of the annular wall portion 19.

In addition, it is not necessary that a relationship of the heights H1 and H2 (H2a) is a relationship in which H2 (H2a) is always higher than H1. However, by setting a length of the annular wall portion 19 to the extent that H2 (H2a) is higher than H1, the water which infiltrates from the additional duct 2 side is unlikely to leak to an outside.

### Operation Effect of Embodiment

Next, an operation effect of the above-described embodiment will be described. In the above-described embodiment, the air conditioning duct 20 provided with the heat exchanger which adjusts the temperature of the conditioning air is provided. The blower casing 8 is provided on the upstream side of the air conditioning duct 20. The blower 9 which sends the conditioning air into the air conditioning duct 20 is provided inside the blower casing 8.

The inside/outside air case 1 which includes the damper 5 that selects and sends one of the outside air which is the air on the outside of the vehicle and the inside air which is the air that circulates inside the vehicle, into the blower casing 8, is provided. In order to send the outside air into the inside/outside air case 1, the additional duct 2 is provided between the vehicle outside-air inlet 3, which is provided on the vehicle side and sucks in the outside air, and the inside/outside air case 1.

The sealing surface 16 is provided on the opening end surface 15 of the inside/outside air case 1 which connects the additional duct 2. As illustrated in FIG. 6, the sealing surface 16 is configured of a part of the opening end surface 15 which is connected to the vehicle outside-air inlet 3 via the sealing packing 13p. As illustrated in FIGS. 2 to 5, the sealing surface 16 is fitted to the protruding portion 18 provided in the end portion of the additional duct 2, and includes the recessed portion 17 which forms the fitting portion together with the protruding portion 18.

According to this, the sealing surface 16 provided on the opening end surface 15 of the inside/outside air case 1 functions as a connection surface which is connected to the additional duct 2, and as a connection surface which is connected to the vehicle outside-air inlet 3 via the sealing packing 13p. Therefore, it is possible to provide the vehicle outside-air inlet 3 in the inside/outside air case 1 via the additional duct 2, or to directly connect the vehicle outside-air inlet 3 to the inside/outside air case 1 via the sealing packing 13p. Therefore, when the vehicle outside-air inlet 3 and the inside/outside air case 1 are connected to each other, since it is possible to use the additional duct 2, or to not use the additional duct 2, the inside/outside air case 1 having the same standard (specification) can be used in the vehicles having different dimensions.

When the vehicle outside-air inlet 3 is directly connected to the inside/outside air case 1, it is possible to easily perform the connection by providing only the sealing packing 13p in the sealing surface 16. Meanwhile, when the additional duct 2 is used, the protruding portion 18 of the additional duct 2 is fitted into the recessed portion 17 of the sealing surface 16, so that it is possible to easily connect the inside/outside air case 1 and the additional duct 2 to each other.

Further, the end portion of the additional duct 2 includes the annular wall portion 19 which inserts more further inside the inside/outside air case 1 than the sealing surface 16 when the additional duct 2 and the inside/outside air case 1 are connected to each other.

Accordingly, even when the water infiltrates from the vehicle outside-air inlet 3 together with the outside air, the water is guided into the inside/outside air case 1 along the wall portion 19 (refer to an arrow Y30 of FIGS. 3 to 5). Accordingly, it is possible to restrict the water from being guided to the outside of the inside/outside air case 1 through the space between the additional duct 2 and the inside/outside air case 1. Therefore, it is possible to restrict the water from infiltrating into an unpredictable part of the vehicle.

Next, as illustrated in FIG. 7, the sealing surface 16 includes the annular flat portion 16 on which the sealing packing 13p (FIG. 6) is disposed. The flat portion 16 includes the outside air inlet port 7 which introduces the outside air to the inner circumferential side of the flat portion 16, and the recessed portion 17 is provided in the flat portion 16.

Therefore, it is possible to install the annular sealing packing 13p in the sealing surface 16, and to directly combine the vehicle outside-air inlet 3 with the inside/outside air case 1. In addition, it is possible to seal the periphery of the outside air inlet port 7 by the sealing packing 13p provided in the sealing surface 16.

Next, the protruding portion 18 is configured of the annular protruding portion 18 which surrounds the periphery of the outside air inlet port 7 of the inside/outside air case 1 in an annular shape, and the annular wall portion 19 is provided on the inner circumferential side of the annular protruding portion 18. According to this, as illustrated in FIG. 3, the connection portion between the inside/outside air case 1 and the additional duct 2 is surrounded by the annular wall portion 19 on the inner circumferential side and the annular protruding portion 18 on the outer circumferential side in a double layer. Therefore, even when the water infiltrates into the additional duct 2 together with the outside air, it is possible to reliably restrict the water from leaking to the outside of the additional duct 2 or the inside/outside air case 1.

Next, when the inside/outside air case 1 and the additional duct 2 are fitted to each other, the protruding portion 18 and the annular wall portion 19 are parallel to each other. In addition, as illustrated in FIGS. 3 to 5, the height H2 (H2a) from the opening end surface 15 (15t) to the tip end of the annular wall portion 19 is higher than the height H1 from the opening end surface 15 to the tip end of the protruding portion 18.

Specifically, as illustrated in FIGS. 3 and 4, the height H2 from the opening end surface 15 to the tip end of the annular wall portion 19 is set to be higher than the height H1 from the opening end surface 15 which is a facing end surface between the inside/outside air case 1 and the additional duct 2 to the tip end of the protruding portion 18. In FIG. 5, the height from the opening end surface 15 which is the facing end surface between the inside/outside air case 1 and the additional duct 2 to the tip end of the protruding portion 18 is H1. The height H2a from the opening end surface 15t on the additional duct 2 side which is the facing end surface between the inside/outside air case 1 and the additional duct 2 to the tip end of the annular wall portion 19 is set to be higher than the height H1.

According to this, when the inside/outside air case 1 and the additional duct 2 are combined with each other, after inserting the annular wall portion 19 into the inside/outside air case 1, it is possible to make the recessed portion 17 of the opening end surface 15 and the protruding portion 18 provided in the end portion of the additional duct 2 fit to each other, and thus assembly becomes easy. In addition, since the height of the annular wall portion 19 is relatively high, it is possible to more reliably restrict the water from leaking to the outside of the additional duct 2 or the inside/outside air case 1.

### Other Embodiments

In the above-described embodiment, a preferable embodiment of the present disclosure is described, but the present disclosure is not limited to any of the above-described embodiments, and can be modified and carried out in various manners without departing the scope of the main idea of the present disclosure. The structure of the above-described embodiment is merely an example, and the scope of the present disclosure is not limited to the described scope. The scope of the present disclosure is described by the description of the scope of the appended claims, and further, includes a meaning which is equivalent to the description of the scope of the patent claims, and all of the modifications within the scope.

The sealing packing 23p (FIG. 1) between the vehicle outside-air inlet 3 and the additional duct 2, and the sealing packing 13p (FIG. 6) between the vehicle outside-air inlet 3 and the inside/outside air case 1, may be formed integrally with the vehicle outside-air inlet 3, and a separate packing may be affixed to the vehicle outside-air inlet 3.

In the above-described embodiment, the entire surface of the sealing surface 16 is configured of the flat portion 16, but a part of the sealing surface 16 may be the flat portion. In other words, a part which is not flat in the sealing surface 16 may exist. In other words, the sealing may be configured by using the sealing packing 13p, and the additional duct 2 and the inside/outside air case 1 may be connected to each other.

In addition, by making the recessed portion 17 and the protruding portion 18 fitted to each other, the inside/outside air case 1 and the additional duct 2 are connected to each other. However, by using a fastening tool, such as a tapping screw, which is not illustrated, the inside/outside air case 1 and the additional duct 2 may be connected to each other.

What is claimed is:

1. A vehicle air-conditioning device, comprising:
an air conditioning duct having a heat exchanger that adjusts a temperature of conditioning, air;
a blower casing disposed upstream of the air conditioning duct, the blower casing housing therein a blower that blows the conditioning air into the air conditioning duct;
an inside/outside air case having a damper that selectively sends outside air, which is air outside of a vehicle, and inside air, which circulates inside the vehicle, into the blower casing;
a vehicle outside-air inlet taking in the outside air, an additional duct being connectable between the vehicle outside-air inlet and the inside/outside air case to send the outside air into the inside/outside air case;
a sealing surface formed on an opening end surface of the inside/outside air case that is connected to the additional duct when the additional duct is used, the sealing surface being configured to be directly connectable to the vehicle outside-air inlet when the additional duct is not used; and
a recessed portion formed in the sealing surface, a protruding portion formed on an end portion of the additional duct being fitted into the recessed portion to form a fitting portion together with the recessed portion when the additional duct is used, wherein
the sealing surface includes an annular flat portion on which a sealing packing is disposed,
the annular flat portion includes an outside air inlet port through which the outside air is introduced to an inner circumferential side of the annular flat portion,
the recessed portion is formed in the annular flat portion, and
when the additional duct is not used, a sealing packing is disposed in the annular flat portion of the sealing surface to directly connect the vehicle outside-air inlet to the inside/outside air case through the sealing packing.

2. The vehicle air-conditioning device according to claim 1, wherein
the end portion of the additional duct includes an annular wall portion that positions radially more inward of the inside/outside air case than the sealing surface when the additional duct and the inside/outside air case are connected to each other.

3. (canceled)

4. The vehicle air-conditioning device according to claim 2, wherein
the protruding portion annually surrounds a periphery of the outside air inlet port of the inside/outside air case, and
the annular wall portion is disposed at an inner circumferential side of the protruding portion.

5. The vehicle air-conditioning device according to claim 2, wherein
the protruding portion and the annular wall portion are in parallel each other when the inside/outside air case and the additional duct are connected to each other, and
a height from the sealing surface to a tip end of the annular wall portion is higher than a height from the sealing surface to a tip end of the protruding portion.
